(19) United States
(12) Patent Application Publication
(10) Pub. No.: US 2013/0222817 A1
(43) Pub. Date: Aug. 29, 2013

(54) IMAGE FORMING DEVICE, IMAGE FORMING METHOD, AND RECORDING MEDIUM

(71) Applicants: Takeshi SUZUKI, Kanagawa (JP); Hiroaki OONO, Tokyo (JP)

(72) Inventors: Takeshi SUZUKI, Kanagawa (JP); Hiroaki OONO, Tokyo (JP)

(73) Assignee: Ricoh Company, Ltd., Tokyo (JP)

(21) Appl. No.: 13/780,057

(22) Filed: Feb. 28, 2013

(30) Foreign Application Priority Data
Feb. 29, 2012 (JP) 2012-043905

(51) Int. Cl. G06F 3/12

(52) U.S. Cl. CPC G03G 15/5058
USPC 358/1.1

(57) ABSTRACT

An image forming device includes a processing unit to control an image formation unit to form an image on a print medium. The processing unit includes a feature extraction processing unit to extract a predetermined feature from an area in a predetermined image, the image area to be filled with a printing material of a special color; a pattern selecting unit to search a registering unit in which filling patterns are registered, and select, from among the filling patterns, a filling pattern having a feature most closely approximating the extracted predetermined feature; and a special-color data generating unit to generate a special-color data of the selected filling pattern. The image formation unit is controlled to form an image in which the special-color data from the special-color data generating unit overlaps image data of the area of the predetermined image.

### BACKGROUND OF THE INVENTION

1. Field of the Invention

The present disclosure relates to an image forming device, an image forming method, and a recording medium which are adapted to generate special color data for overlapping image data of an image area.

2. Description of the Related Art

Conventionally, an image forming device may protect a surface of a print medium using toner or ink of a special color other than CMYK (for example, transparent or clear toner), or an image forming device may give a gloss to a surface of a print medium by applying toner or ink of a special color.

For example, Japanese Laid-Open Patent Publication No. 2008-532066 discloses a conventional image forming device in which clear toner patterns are stored beforehand in a memory, an area of an image to which such a pattern is to be added is designated on a display, and a selected clear toner pattern from among the stored clear toner patterns is added to the designated area of the image data.

Japanese Laid-Open Patent Publication No. 2008-145453 discloses a conventional image forming device in which clear toner patterns, such as logo patterns or wave-shaped patterns, are registered on an operation panel, a registered pattern is selected from among the clear toner patterns, and a clear toner image is formed on a sheet of a color image using the selected registered pattern.

Among the applications using the clear toner, some applications may provide a printed surface with a visual or tactile representation for giving a feeling of gloss or a feeling of unevenness to the printed surface. For example, an uneven pattern is formed on a surface of a print medium so that the surface with the uneven pattern formed may provide a feeling of coarseness when the surface is touched by hand.

However, if a user wishes to generate the above-described pattern data of a special color, the user's supplementary work becomes complicated. Hence, the demand for automating the work of generation and registration of parameters needed to obtain the printing effects of the special color arises.

### SUMMARY OF THE INVENTION

In one aspect, the present disclosure provides an image forming device which is able to reduce the amount of the supplementary work concerning generation of pattern data required to obtain the printing effect of a special color, and increase the working efficiency.

In an embodiment which solves or reduces one or more of the above-mentioned problems, the present disclosure provides an image forming device including a processing unit to control an image formation unit to form an image on a print medium, the processing unit including: a feature extraction processing unit configured to extract a predetermined feature from an area in a predetermined image, the image area to be filled with a printing material of a special color; a pattern selecting unit configured to search a registering unit in which filling patterns are registered, and select, from among the filling patterns registered in the registering unit, a filling pattern having a feature most closely approximating the extracted predetermined feature; and a special-color data generating unit configured to generate a special-color data of the selected filling pattern, wherein the image formation unit is controlled to form an image in which the special-color data from the special-color data generating unit overlaps image data of the area of the predetermined image.

Other objects, features and advantages of the present disclosure will be more apparent from the following detailed description when read in conjunction with the accompanying drawings.

### BRIEF DESCRIPTION OF THE DRAWINGS

FIG. 1 is a diagram for explaining the composition of an image forming device according to an embodiment of the present disclosure.

FIG. 2 is a flowchart for explaining an image forming process according to the embodiment 1 of the present disclosure.

FIG. 3A and FIG. 3B are diagrams showing examples of input images and filling patterns.

FIG. 4 is a flowchart for explaining a process performed by a pre-processing unit of the image forming device.

FIG. 5 is a flowchart for explaining a process performed by a feature extraction processing unit of the image forming device.

FIG. 6 is a diagram for explaining selection of a filling pattern.

FIG. 7 is a flowchart for explaining a distance computation process performed by a pattern selecting unit of the image forming device.

FIG. 8 is a flowchart for explaining a pattern selection process performed by the pattern selecting unit of the image forming device.

FIGS. 9A-9C are diagrams for explaining a registration processing of filling patterns.

FIG. 10 is a flowchart for explaining a process performed by a filling pattern registering unit of the image forming device.

FIG. 11 is a flowchart for explaining a process performed by a special-color data generating unit of the image forming device.

FIG. 12 is a diagram showing an example of a GUI in a case of automatic selection.

FIG. 13 is a flowchart for explaining a process of automatic selection according to the embodiment 2 of the present disclosure.

FIG. 14 is a flowchart for explaining a process of generating a special-color data according to the embodiment 3 of the present disclosure.

FIG. 15 is a diagram showing an example of an LUT (look-up table) in which the objects and the special color patterns are associated with each other.

FIG. 16 is a flowchart for explaining a process of generating a special-color data according to the embodiment 4 of the present disclosure.

FIG. 17 is a flowchart for explaining a manual registration process according to the embodiment 5 of the present disclosure.

FIG. 18 is a flowchart for explaining a detailed procedure of step 1403 in the process of FIG. 17.

FIG. 19 is a flowchart for explaining a process of generating a special-color data according to the embodiment 6 of the present disclosure.

FIG. 20 is a flowchart for explaining a modification of the process of generating the special-color data according to the embodiment 6 of the present disclosure.

FIG. 21 is a flowchart for explaining a process of generating a special-color data according to the embodiment 7 of the present disclosure.

FIGS. 22A and 22B are diagrams showing examples of a database which manages the printing effects and the filled layers.

FIG. 23 is a flowchart for explaining a modification of the process of generating the special-color data according to the embodiment 7 of the present disclosure.

FIG. 24 is a block diagram showing the hardware composition of an image processing device in which the image forming device according to the present disclosure is implemented by software.

### DETAILED DESCRIPTION OF THE PREFERRED EMBODIMENTS

A description will be given of embodiments of the present disclosure with reference to the accompanying drawings.

Fundamentally, according to the concept of the present disclosure, in order to automatically generate and manage toner data of a special color, a printing effect of a special color and its corresponding toner data of the special color are associated beforehand. When the printing effect of the special color is selected by a user, the corresponding toner data is automatically generated by using the associated data structure.

There may be a case in which it is necessary to control the processing parameters of a corresponding process and control the amount of the toner used for printing, in order to obtain the printing effect of the special color. In this case, the processing parameters of the corresponding process are generated as data accompanying the original document, and the automation and simplification of the work can be provided.

In addition, with respect to the printing effect of each special color, the corresponding toner data and the processing parameters of the corresponding process are associated. When the printing effect of the special color is designated by the user, the toner data of the special color and the processing parameters are generated using the associated data structure.

Further, when input document data is divided into areas (for example, when the input document data is provided in the vector format used in the Desktop Publishing (DTP)), the shape of each area in the original document is used, the area of the special color corresponding to the shape of the area is automatically determined, and the amount of the user's work is reduced.

### Embodiment 1

The terminology used in the description of the present disclosure is for the purpose of describing particular embodiments only and is not intended to be limiting of the present disclosure. Some terms used herein will be described.

A “special color” is an unusual color other than four colors of CMYK (cyan, magenta, yellow, black) used in the normal printing process, and also refers to a toner or ink of an unusual color.

A “special-color printing effect” includes a printing effect, such as giving a feeling of gloss or a feeling of unevenness to the printed surface, and a printing effect obtained by the special color expression.

“DTP” is the abbreviation of Desktop Publishing and means the creation of printed materials using page layout on a personal computer. DTP may also refer to the Desktop Publishing tools or processes.

A “vector form” is one of forms of electronic documents in which the documents and image information are expressed as vectors and the vector expression is retained. The vector form is often used in the DTP as the main electronic document form.

A “raster form” is one of forms of electronic documents in which the image information is expressed as values of the respective pixels, and the pixel value expression is retained. The raster form is often used in a digital photographic image or the like.

A “color data” is the electronically generated image data for printing, and refers to the image data of the divided color components of the developing device provided in the image forming device. For example, when the image forming device is provided to use four color components of CMYK for printing, the image forming device is normally arranged to generate four color data items corresponding to the four color components for color printing.

A “layer” is one of the electronic expression forms of a document used in the DTP. In a case of a document including plural image portions, each image portion is referred to as a layer. In some embodiments of the present disclosure, plural color data items are expressed as plural layers. For example, when a document data includes four colors of CMYK, the document data is expressed by the four layers corresponding to the four colors of CMYK.

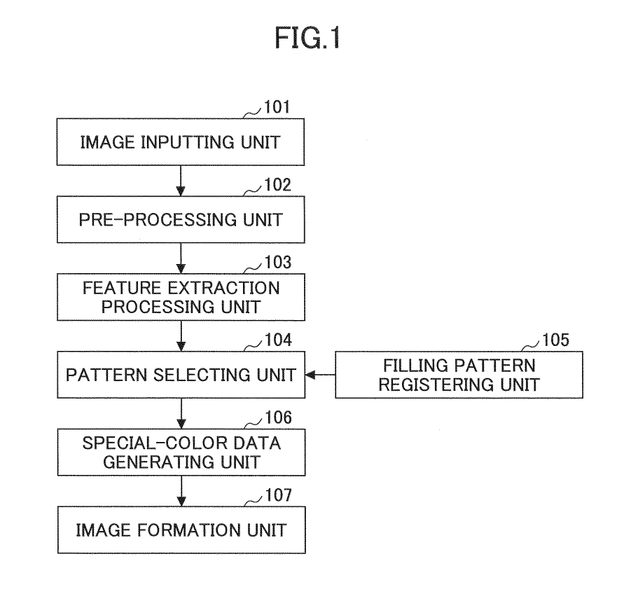

FIG. 1 shows the composition of an image forming device according to an embodiment of the present disclosure.

As shown in FIG. 1, the image forming device of this embodiment includes an image processing unit and an image formation unit 107. The image processing unit includes an image inputting unit 101, a pre-processing unit 102, a feature extraction processing unit 103, a pattern selecting unit 104, a filling pattern registering unit 105 and a special-color data generating unit 106. The output of the special-color data generating unit 106 is supplied to the image formation unit 107. These component units of the image forming device of the present disclosure will be described below individually.

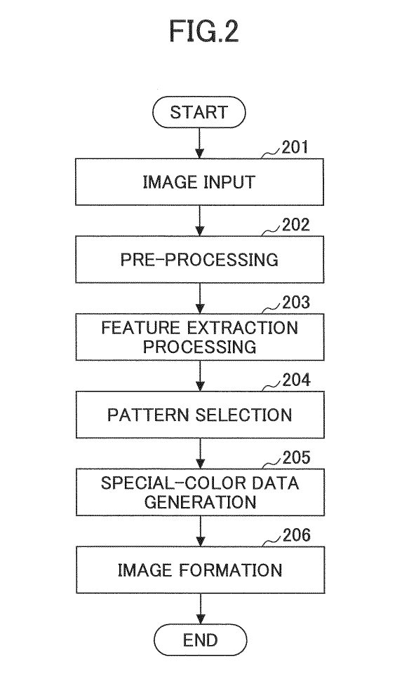

FIG. 2 is a flowchart for explaining an image forming process performed by the image forming device according to the embodiment 1 of the present disclosure. In this embodiment, it is assumed that image data of a DTP document in which raster image information, including photographic images, and vector image information, including line drawings, coexist in a mixed manner is input to the image forming device.

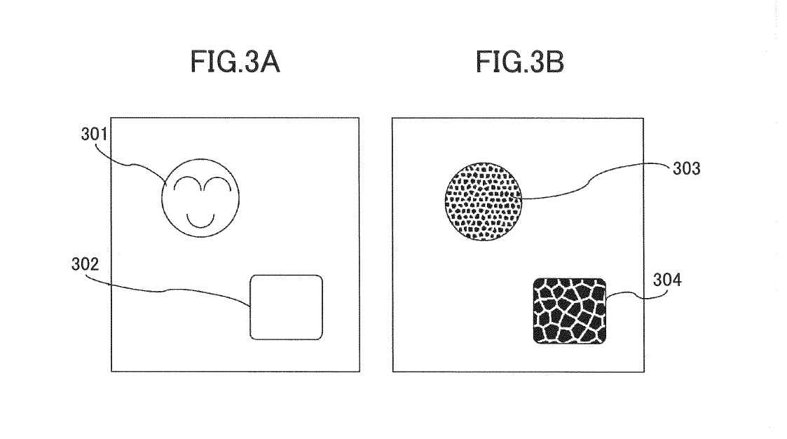

FIG. 3A shows an example of an input image which is input to the image forming device by the image inputting unit 101. In some embodiments of the present disclosure, DTP image areas 301 and 302 which are generated by the DTP process are designated beforehand as objects by a user and input to the image forming device (step 201 in FIG. 2). These designated areas 301 and 302 are image areas that are to be filled with toner of a special color.

FIG. 3B shows examples of filling patterns 303 and 304 which are formed to overlap the DTP image areas 301 and 302 respectively. These filling patterns have respective features that are different in tone, gloss, unevenness, etc.

In the pre-processing unit 102, resolution conversion, noise removal, color space conversion, and raster image selection of the input image; checking of the layer information of the input document; and checking of the registered patterns, etc., are carried out, so that the input image data are arranged in an image form suitable for the pre-processing (step 202 in FIG. 2). The resolution, the color space, etc., appropriate for the pre-processing may be prepared by experiment, or may be selected by the user.

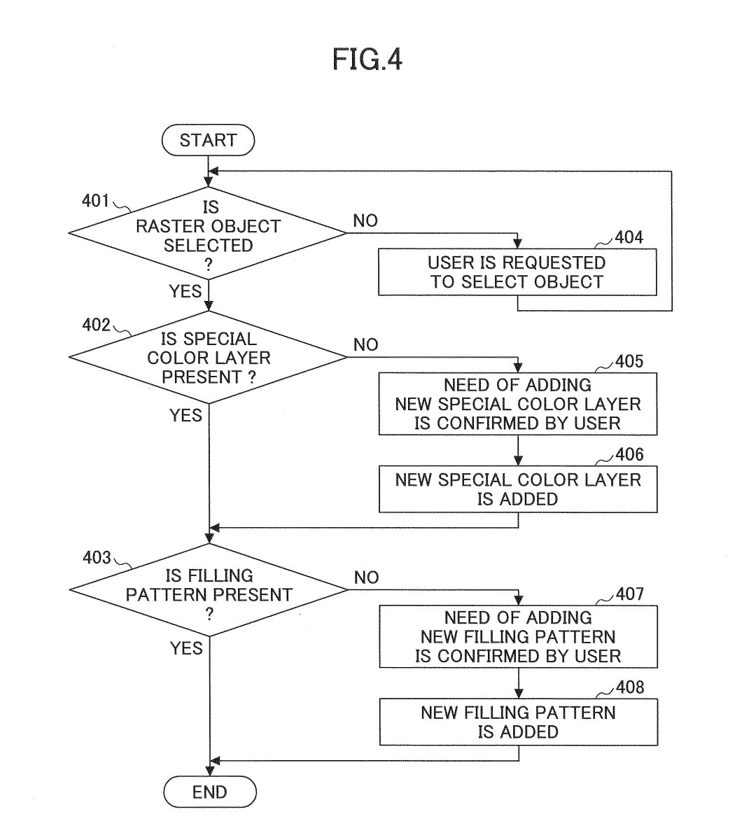

FIG. 4 is a flowchart for explaining a process performed by the pre-processing unit 102 of the image forming device. In some embodiments of the present disclosure, when image data of a DTP document in which raster image information and vector image information coexist in a mixed manner is input as the processing objects, a selection process in which only the raster information (raster object) is selected from the processing objects is performed.

In the process shown in FIG. 4, the pre-processing unit 102 determines whether a raster object is selected with respect to the input image data (step 401). When it is determined in step 401 that a vector image (vector object) is selected with respect to the input image data (NO in step 401), the process is transferred to step 404 in which an area (object) selection procedure is performed again by the user, because the vector image is not processed in this embodiment.

When it is determined in step 401 that the raster object is selected with respect to the input image data, the process is transferred to step 402. In step 402, the pre-processing unit 102 determines whether a special color layer is present in the layer information of the input document. The pre-processing unit 102 checks the layer information of the input document, and detects whether the special color layer which is used as the image area to be filled with the toner of the special color already exists in the input document.

When it is determined in step 402 that the special color layer is not present, the process is transferred to step 405. In step 405, the pre-processing unit 102 requests the user to confirm the need to newly generate an object (the special color layer) with a predetermined object name and a predetermined data structure. Next, in step 406, the pre-processing unit 102 adds the object (the special color layer) newly generated with the predetermined object name and the predetermined data structure to the layer information.

Subsequently, in step 403, the pre-processing unit 102 determines whether the registered filling pattern which is formed to overlap the image area is present in the input document. When it is determined in step 403 that the registered filling pattern is not present, the process is transferred to step 407. In step 407, the pre-processing unit 102 requests the user to confirm the need to add a new filling pattern to be registered in the filling pattern registering unit 105. Next, in step 408, the pre-processing unit 102 adds the newly registered filling pattern to the filling pattern registering unit 105.

In the process of FIG. 4, the need to add the special color layer and the need to add the filling pattern are confirmed by the user at steps 405 and 407. Alternatively, these confirmation steps 405 and 407 may be omitted.

In some embodiments of the present disclosure, the feature extraction processing unit 103 of the image forming device computes the components of a predetermined feature vector based on the image information of a predetermined image area (step 203 in FIG. 2). For example, the feature extraction processing unit 103 computes feature quantities, including an average color (a primary moment) of pixels of the image area, a standard deviation (a square root of a secondary moment) of pixel values of the image area, and an edge amount of the image area. The feature extraction processing unit 103 uses one of the computed feature quantities or a combination of the computed feature quantities as a feature vector T extracted from the image area.

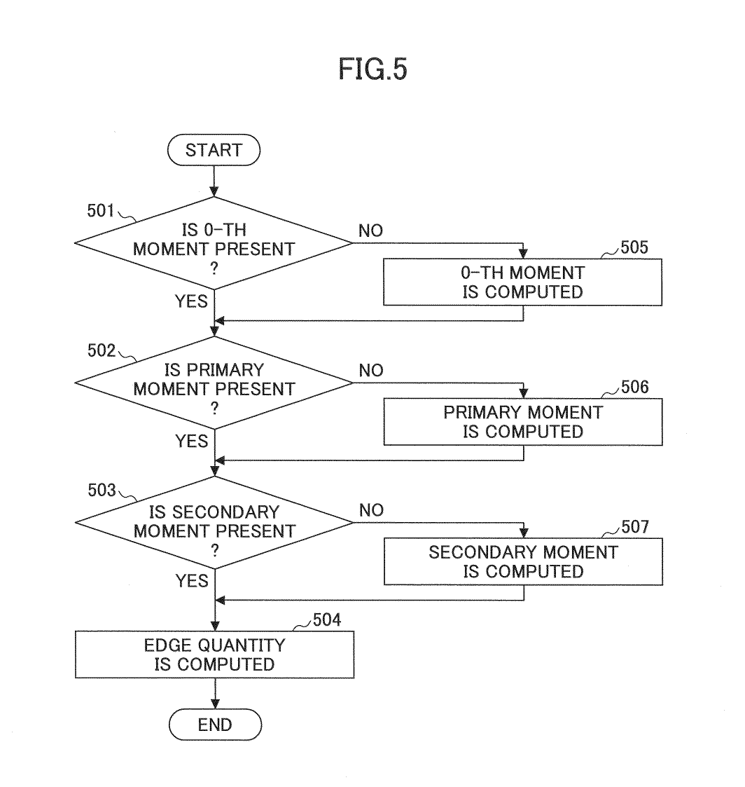

FIG. 5 is a flowchart for explaining a process performed by the feature extraction processing unit 103 of the image forming device.

In the process shown in FIG. 5, the feature extraction processing unit 103 determines whether a 0-th moment is present in the computed feature quantities (step 501). When it is determined in step 501 that the 0-th moment is not present, the process is transferred to step 505. In step 505, the feature extraction processing unit 103 computes the 0-th moment.

Subsequently, the feature extraction processing unit 103 determines whether the primary moment is present in the computed feature quantities (step 502). When it is determined in step 502 that the primary moment is not present, the process is transferred to step 506. In step 506, the feature extraction processing unit 103 computes the primary moment.

Subsequently, the feature extraction processing unit 103 determines whether the secondary moment is present in the computed feature quantities (step 503). When it is determined in step 503 that the secondary moment is not present, the process is transferred to step 507. In step 507, the feature extraction processing unit 103 computes the secondary moment.

Finally, in step 504, the feature extraction processing unit 103 computes the edge quantity.

Because these moments have a dependency relationship therebetween, the computations of the O-th moment (step 505), the primary moment (step 506) and the secondary moment (step 507) are sequentially performed. By performing the process of FIG. 5 in this manner, the whole computation cost can be remarkably reduced.

In some embodiments of the present disclosure, the pattern selecting unit 104 searches the filling pattern registering unit 105 in which several predetermined feature vectors are registered, and selects, from among the registered feature vectors, a filling pattern having a feature vector most closely approximating the extracted feature vector T which is computed based on the image area by the feature extraction processing unit 103 (step 204 in FIG. 2).

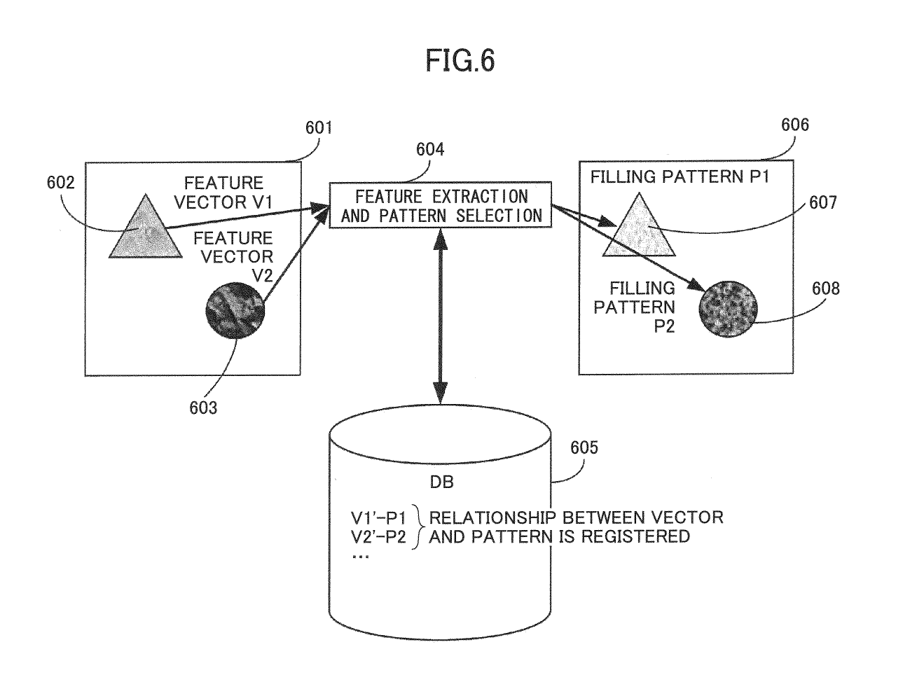

FIG. 6 is a diagram for explaining an example of the selection of the filling pattern using the feature vector. As shown in FIG. 6, a feature extraction processing unit 604 (which includes a selection processing unit) extracts feature vectors V1 and V2 from image areas 602 and 603 designated within an input image 601, respectively. In a filling pattern registering database (DB) 605, the relationship between feature vectors V and filling patterns P in specific image areas of the input image is registered beforehand. The selection processing unit 604 searches the filling pattern registering database (DB) 605 and selects filling patterns P1 and P2 having feature vectors V1′ and V2′ which most closely approximate the extracted feature vectors V1 and V2, respectively. The selected filling patterns 607 and 608 are generated as clear color data 606.

In some embodiments of the present disclosure, the pattern selecting unit 104 includes a distance computation processing unit and a pattern selection processing unit. The distance computation processing unit computes a distance between the feature vector computed based on the image area by the feature extraction processing unit 103 and the feature vector computed from the existing filling patterns. Generally, a distance between vectors can be determined by the inner product of the vectors.

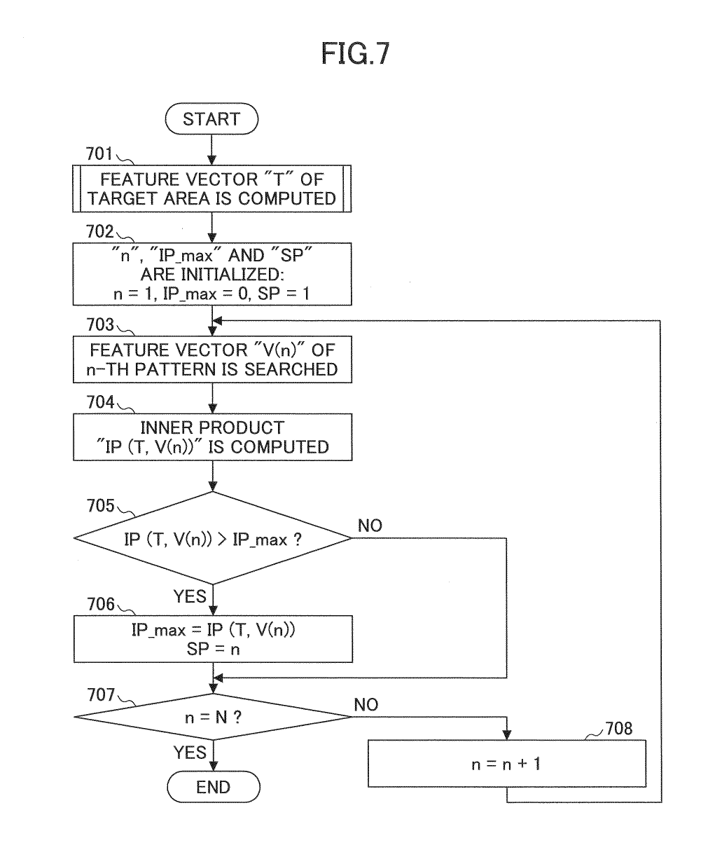

FIG. 7 is a flowchart for explaining a distance computation process which is performed by the pattern selecting unit 104.

Alternatively, if the computation of the distance between the feature vectors is possible, another process other than the distance computation process shown in FIG. 7 may be used.

In the distance computation process of FIG. 7, it is assumed that n denotes the pattern number, T denotes a feature vector of a target area, N denotes the total number of the existing patterns, V(n) denotes a feature vector of the n-th pattern, IP_max denotes the maximum inner product, and SP denotes the selection pattern number.

First, in the distance computation process of FIG. 7, the computation of the feature vector T of the target area is performed by the feature extraction processing unit 103 as described above (step 701).

Next, the pattern number n, the maximum inner product IP_max, and the selection pattern number SP are initialized respectively (step 702): n=1, IP_max=0, SP=1.

Subsequently, the pattern selecting unit 104 searches for the feature vector of the n-th pattern V(n) in the filling pattern registering unit (DB) 105 (step 703), and computes the inner product IP (T, V (n)) (step 704).

Subsequently, the pattern selecting unit 104 determines whether the inner product IP (T, V(n)) computed at step 704 is larger than the maximum inner product IP_max (step 705). When it is determined in step 705 that the computed inner product IP (T, V(n)) is larger than the maximum inner product IP_max, the process is transferred to step 706. In step 706, the IP_max is replaced by the computed inner product IP and the selection pattern number SP is also replaced by the n. On the other hand, when it is determined in step 705 that the computed inner product IP (T, V(n)) is not larger than the maximum inner product IP_max, the step 706 is not performed and the process is transferred to step 707.

Subsequently, in step 707, the pattern selecting unit 104 determines whether the pattern number n is equal to the total number N. When it is determined in step 707 that the pattern number n is not equal to the total number N, the process is transferred to step 708. In step 708, the pattern number n is incremented (n=n+1), and the process is returned back to the step 703.

On the other hand, when it is determined in step 707 that the pattern number n is equal to the total number N, the process is terminated.

By performing the process shown in FIG. 7 repeatedly for all the existing filling patterns, a filling pattern having the feature vector most closely approximating the feature vector T of the target area can be selected from among all the existing filling patterns.

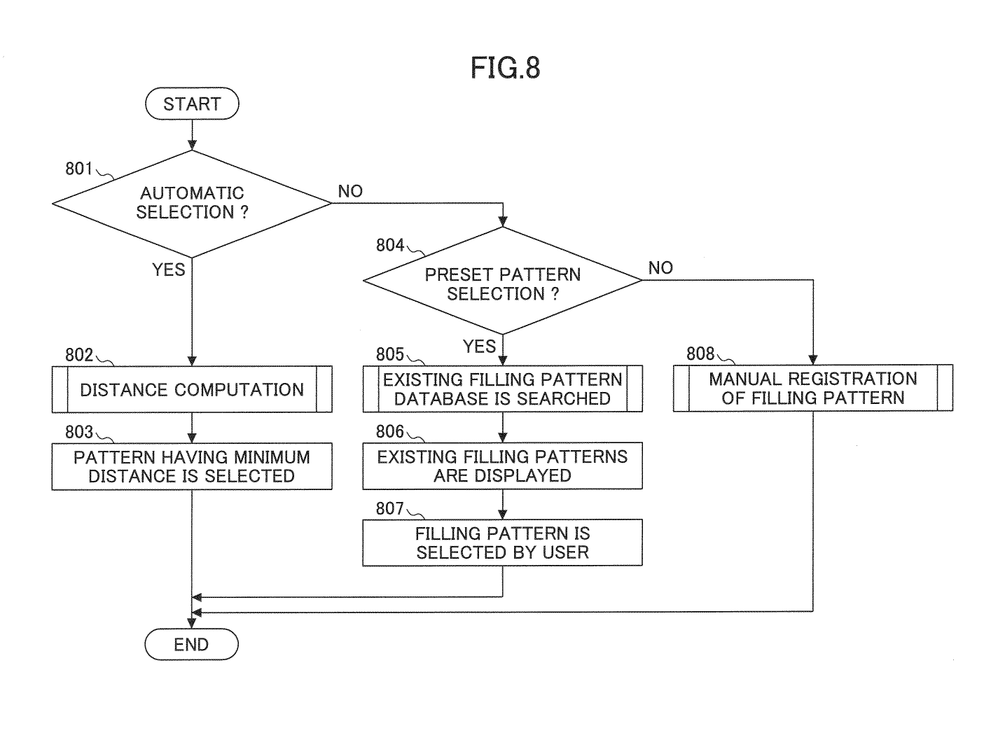

In the pattern selection processing unit of the pattern selecting unit 104, three kinds of options: automatic selection, preset pattern selection, and manual registration by the user are provided. FIG. 8 is a flowchart for explaining a pattern selection process performed by the pattern selecting unit 104.

In the process shown in FIG. 8, the pattern selecting unit 104 determines whether the automatic selection option is selected (step 801).

When it is determined in step 801 that the automatic selection option is selected, the process is transferred to step 802, in which the above-mentioned distance computation is performed. Next, in step 803, the pattern selecting unit 104 automatically selects a filling pattern which has the shortest distance in the feature space (step 803).

When it is determined in step 801 that the automatic selection option is not selected, the process is transferred to step 804. In step 804, the pattern selecting unit 104 determines whether the preset pattern selection option is selected.

When it is determined in step 804 that the preset pattern selection option is selected, the pattern selecting unit 104 searches the existing filling pattern registering database (DB) (step 805). Next, the pattern selecting unit 104 displays a list of available filling patterns (preset patterns) to the user (step 806), and receives a user's selection of a filling pattern from the displayed list of the available filling patterns (step 807). In this case, a list of the preset filling patterns may be displayed to the user for selection, or identification information, including a list of names of the respective present filling patterns, may be displayed to the user for selection.

When it is determined in step 804 that the preset pattern selection option is not selected, the process is transferred to step 808. In step 808, the pattern selecting unit 104 performs manual registration of a filling pattern selected by the user. In the manual registration, the pattern selecting unit 104 first performs a filling pattern registration procedure so that the user is prompted to register a filling pattern manually, and then automatically selects the registration result by the user as a registered filling pattern.

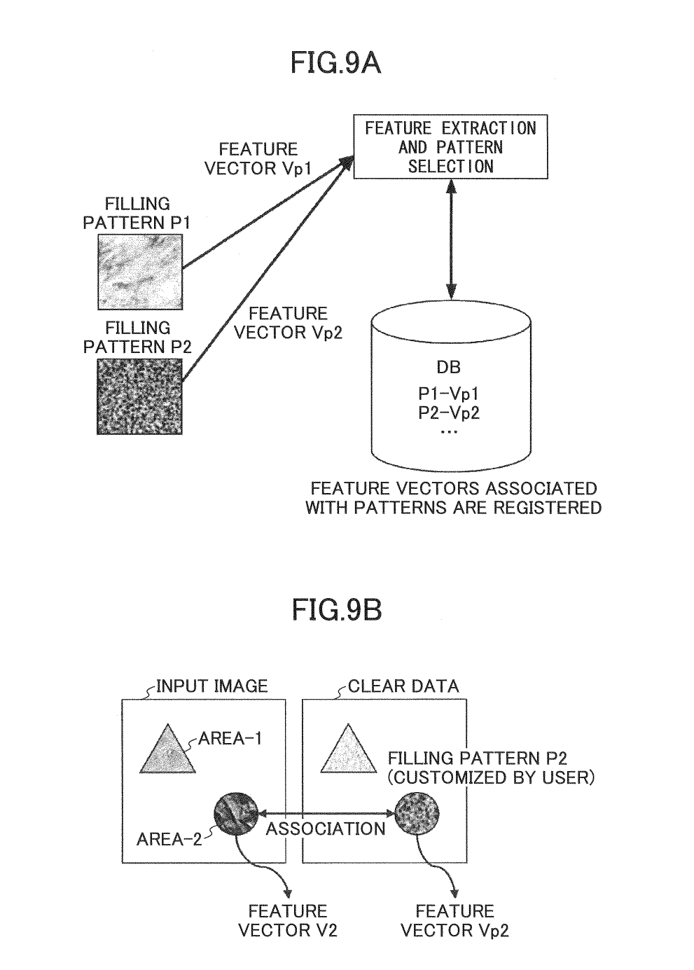

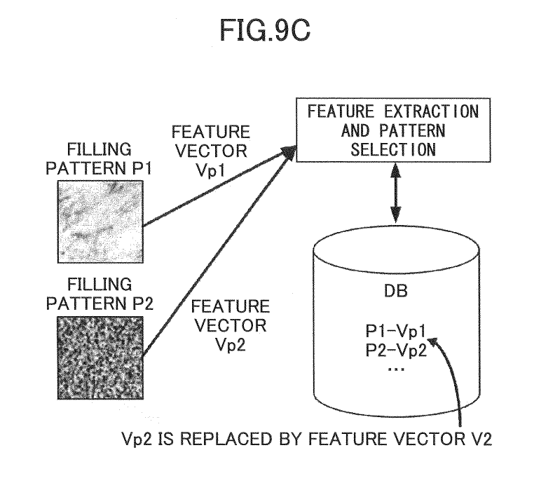

FIGS. 9A-9C are diagrams for explaining the registration processing of filling patterns. As shown in FIG. 9A, at a time of filling pattern registration, feature vectors Vp1 and Vp2 are respectively extracted from filling patterns P1 and P2, and the feature vectors Vp1 and Vp2 are associated with the filling patterns P1 and P2 so that they are registered in a filling pattern registering database (DB).

FIGS. 9B and 9C show the registration processing in a case in which a filling pattern in an area-2 of an image customized by the user as a filling pattern P2 is used for the registration. For example, in the area 2 of the image customized by the user, image data indicating “copy inhibition” is embedded. As will be described later, such image data is subjected to a binarization process or the like, and the filling pattern P2 is generated as a result of the binarization process.

In order to automatically determine a filling pattern for use in special color data, such as clear data, it is preferred to associate the filling pattern P2 with the feature vector V2 of the input image. Namely, it is desirable to enable the management of the kind of the image and the kind of the clear data (filling pattern) used by the user.

As shown in FIG. 9C, a feature vector associated with a filling pattern may be changed. Basically, the filling pattern P2 is to be associated with the feature vector Vp2 extracted from the filling pattern P2, and the filling pattern P2 is to be managed by using the filling pattern registering database (DB). However, when the user newly registers a customized image and prepares clear data corresponding to the area-2 of the customized image, the feature vector V2 extracted from the area-2 of the customized image is used as the feature vector associated with the filling pattern P2, instead of the feature vector Vp2 extracted from the filling pattern P2.

In some embodiments of the present disclosure, in order to generate a filling pattern from an arbitrary input image prepared by the user, the filling pattern registering unit 105 includes a binarization processing unit, a replacement processing unit which replaces a feature vector extracted from a filling pattern by a feature vector computed from an image area of the input image designated by the user at the time of pattern registration, and a filling pattern registering database DB which is used by the replacement processing unit.

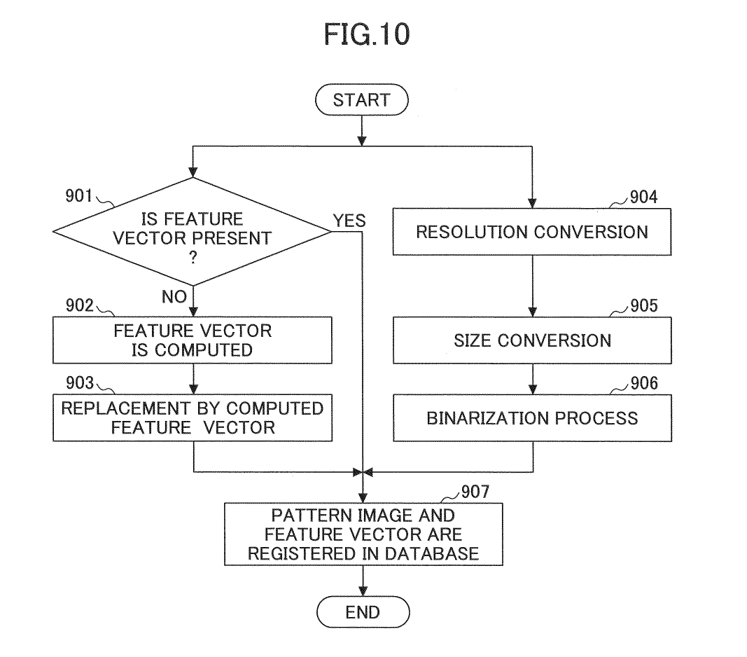

FIG. 10 is a flowchart for explaining a process performed by the filling pattern registering unit 105.

In the process shown in FIG. 10, the filling pattern registering unit 105 performs a resolution conversion process which converts a resolution of an arbitrary input image into a predefined resolution (step 904), performs a size conversion process which converts a size of the input image into a pre-defined size (step 905), and performs the binarization process of the input image (step 906). Then, the process is transferred to step 907.

In parallel with these steps, the filling pattern registering unit 105 determines whether a feature vector computed from the input image is present (step 901). When it is determined in step 901 that the computed feature vector is not present, the process is transferred to step 902. In step 902, the filling pattern registering unit 105 computes the feature vector from the input image. Next, in step 903, the filling pattern registering unit 105 replaces the feature vector of the filling pattern by the computed feature vector. Then, the process is transferred to step 907. On the other hand, when it is determined in step 901 that the computed feature vector is present, the process is transferred to step 907.

Finally, the filling pattern registering unit 105 performs the pattern registering process which registers the pattern image and the feature vector into the database DB (step 907).

In some embodiments of the present disclosure, the special-color data generating unit 106 generates layer content information (step 205 in FIG. 2). The special-color data generating unit 106 manages special-color data as a unique layer that is independent of the input image information. The unique layer managed by the special-color data generating unit 106 may be prepared by the pre-processing unit 102.

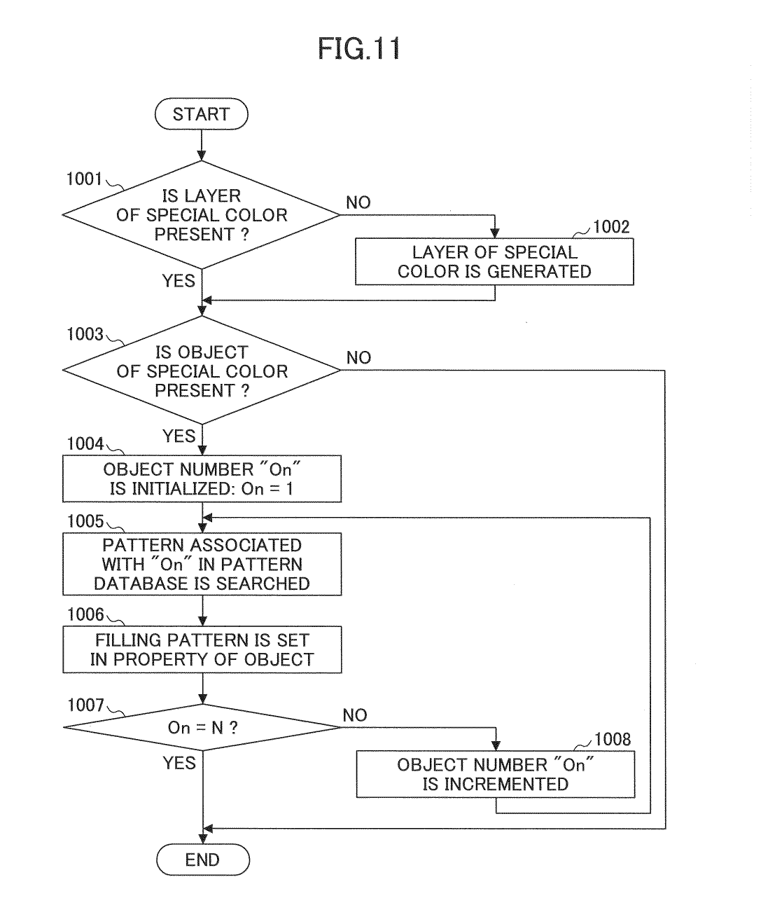

FIG. 11 is a flowchart for explaining a process performed by the special-color data generating unit 106.

In the process shown in FIG. 11, the special-color data generating unit 106 determines whether a layer of a special color is present (step 1001). When it is determined in step 1001 that the special color layer is not present, the special-color data generating unit 106 generates the special color layer (step 1002). When it is determined in step 1001 that the special color layer is present, the process is transferred to step 1003.

In step 1003, the special-color data generating unit 106 determines whether an object of the special color is present. When it is determined in step 1003 that the special color object is present, the process is transferred to step 1004. When it is determined in step 1003 that the special color object is not present, the process is terminated.

In step 1004, the special-color data generating unit 106 initializes the object number On: On=1. Next, in step 1005, the special-color data generating unit 106 searches for a filling pattern associated with the object number On in the filling pattern registering database (DB). Next, in step 1006, the special-color data generating unit 106 sets the filling pattern (the searching result) in the property of the special-color object.

Subsequently, the special-color data generating unit 106 determines whether the object number On is equal to the total number N (N>0) of objects that are to be written to the special-color layer (step 1007). When it is determined in step 1007 that the object number On is not equal to the total number N, the object number On is incremented: On=On+1 (step 1008). Then, the process is transferred to step 1005. On the other hand, when it is determined in step 1007 that the object number On is equal to the total number N, the process is terminated.

In this embodiment, it is assumed that image data of a DTP document in which raster image information, including photographic images, and vector image information, including line drawings, coexist in a mixed manner is input to the image forming device. A new layer of special color data is additionally provided in the image data of the DTP document, and the image formation unit 107 is controlled to form an image in which the special color data overlaps the image data of the selected area of the DTP document. A filling pattern which is appropriate for the special color expression is given to each of the objects which are present in the special color layer, respectively.

In the filling patterns 303 and 304 (the contents of the special color layer to be added) shown in FIG. 3B, the contents of the special color layer are respectively added to the input DTP image areas 301 and 302 shown in FIG. 3A, and an image in which the special color data overlaps the image data of the areas of the DTP image is formed.

In some embodiments of the present disclosure, the image formation unit 107 uses the toners or inks of CMYK and a printing material, such as a special-color or transparent toner or ink, and forms such an image (as shown in FIG. 3B) by performing the known electrophotographic or ink-jet printing process (step 206 in FIG. 2).

Accordingly, the filling pattern appropriate for the area to be filled in is selected and the special-color data is generated, and the amount of the supplementary work concerning generation of the pattern data required to obtain the printing effect of the special color can be reduced and the working efficiency can be increased.

### Embodiment 2

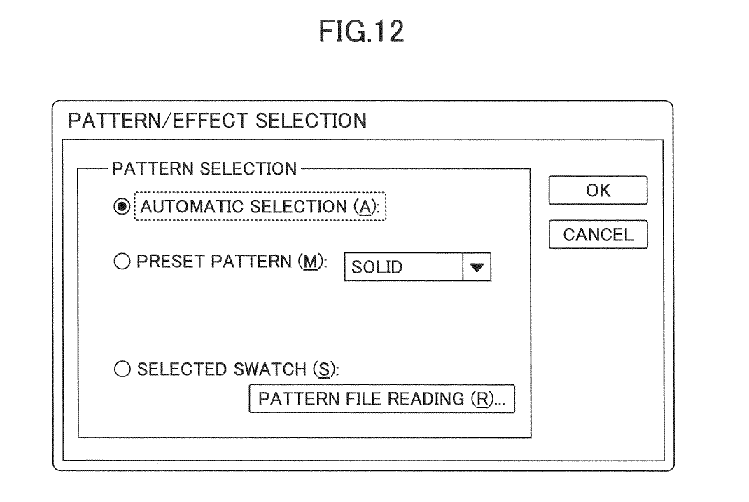

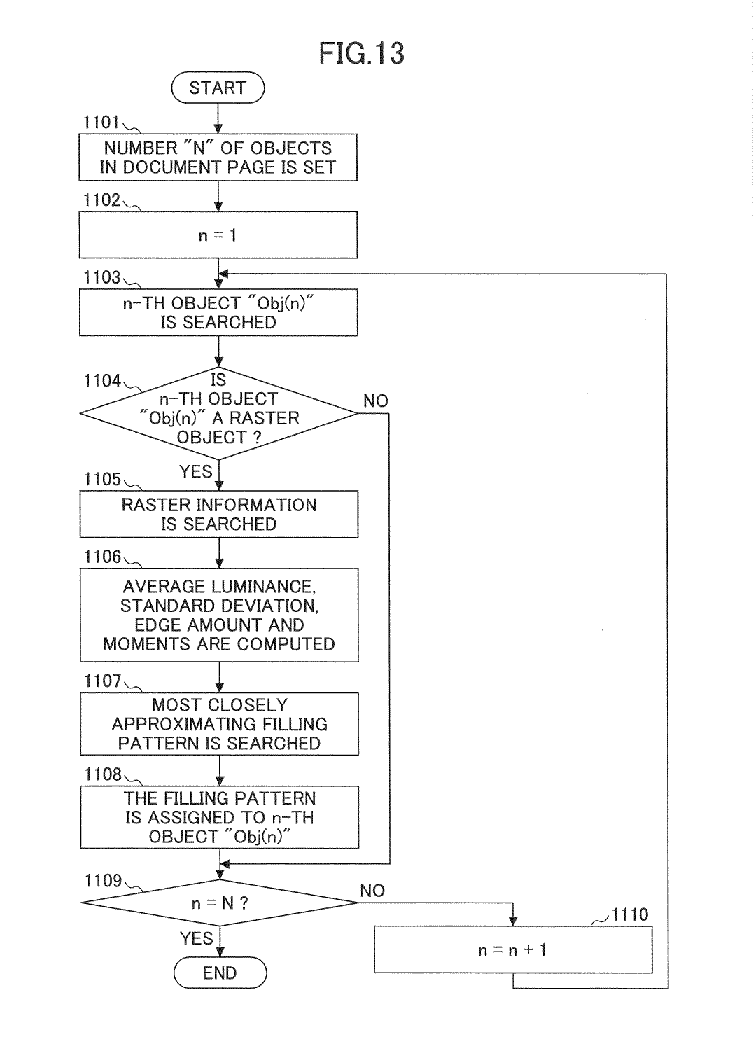

The present embodiment is directed to a modification of the automatic selection of a filling pattern. FIG. 12 shows an example of a GUI (graphical user interface) in a case of the automatic selection. FIG. 13 is a flowchart for explaining the detailed process of the automatic selection according to the present embodiment.

In the present embodiment, there are plural filling patterns that can be used, and the feature vectors as described above are computed beforehand from the filling patterns, respectively.

In the process of the automatic selection shown in FIG. 13, the pattern selecting unit 104 sets the total number N of objects contained in the document page (step 1101). Next, the pattern selecting unit 104 initializes the object number n: n=1 (step 1102). Next, the pattern selecting unit 104 searches for the n-th object “Obj(n)” (step 1103). Next, the pattern selecting unit 104 determines whether the n-th object “Obj(n)” is a raster object (step 1104). When the result of the determination at step 1104 is negative (not a raster object), the process is transferred to step 1109. When the result of the determination at step 1104 is affirmative (a raster object), the process is transferred to step 1105.

In step 1105, the pattern selecting unit 104 searches for the raster information of the n-th object “Obj(n)”. Next, in step 1106, the pattern selecting unit 104 computes the components of the target feature vector based on the raster information, including an average color or an average luminance of pixels of the raster object, a standard deviation of pixel values (luminance) of the raster object, and an edge amount of the raster object.

Subsequently, the pattern selecting unit 104 searches, from among the feature vectors computed beforehand from the filling patterns, for a feature vector most closely approximating the target feature vector by using the most likelihood method (step 1107), and the pattern selecting unit 104 assigns the filling pattern to the object with the object number n in the document page (step 1108).

Subsequently, in step 1109, the pattern selecting unit 104 determines whether the object number n is equal to the total number N. When it is determined in step 1109 that the object number n is not equal to the total number N, the process is transferred to step 1110. In step 1110, the object number n is incremented (n=n+1), and the process is returned back to the step 1103. When it is determined in step 1109 that the object number n is equal to the total number N, the process is terminated.

As in the process of the automatic selection shown in FIG. 13, only when the selected object “Obj(n)” is a raster image, the pattern selecting unit 104 uses the raster information thereof and determines the assignment of the filling pattern (step 1108).

In the present embodiment, the most likelihood method is used (step 1107). Alternatively, another searching method different from the most likelihood method may be used.

### Embodiment 3

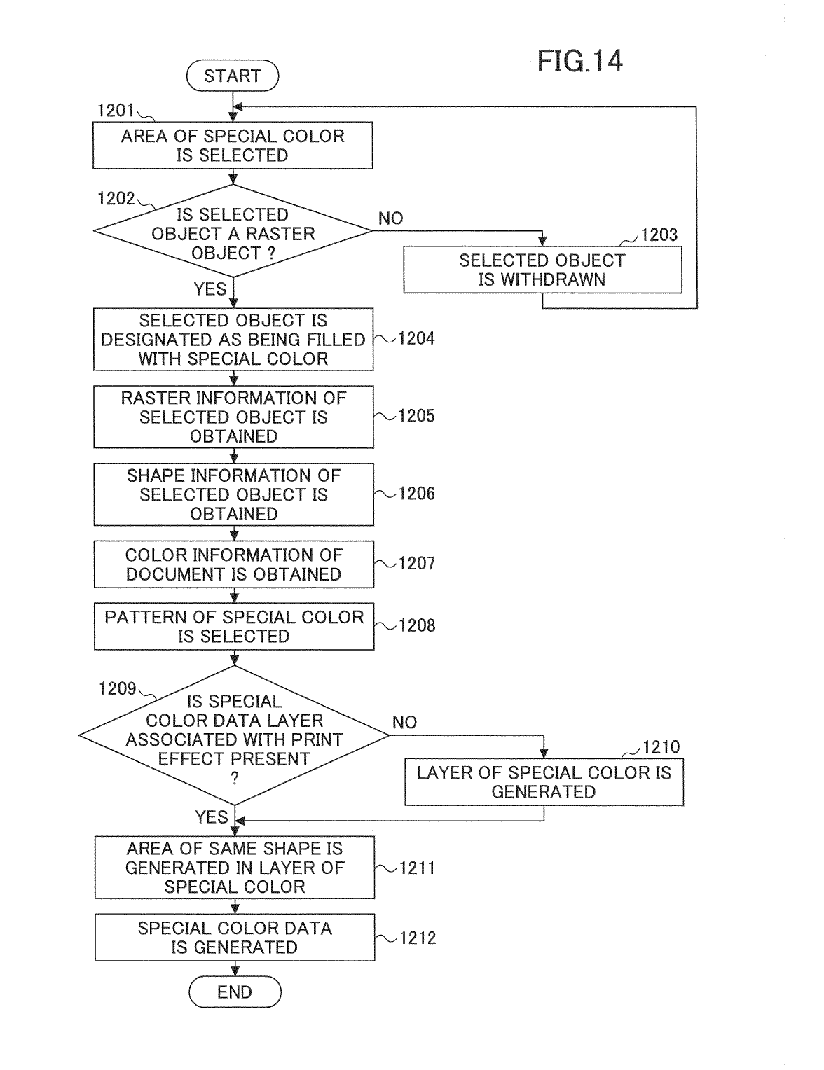

The present embodiment is directed to a modification of the process of generating a special-color data. FIG. 14 is a flowchart for explaining the process of generating a special-color data which is performed by the special-color data generating unit 106 according to the present embodiment. The process shown in FIG. 14 is similar to the process shown in FIG. 11, therefore a duplicate description thereof will be omitted, and only the difference between the processes of FIG. 11 and FIG. 14 will be described.

In the process shown in FIG. 14, when determining the special color data using the raster information of the area of the selected object, the raster information of the selected object is obtained (steps 1201-1207), and the special color pattern is selected based on the raster information (step 1208). In this embodiment, only when the selected object is a raster object, the subsequent steps are processed.

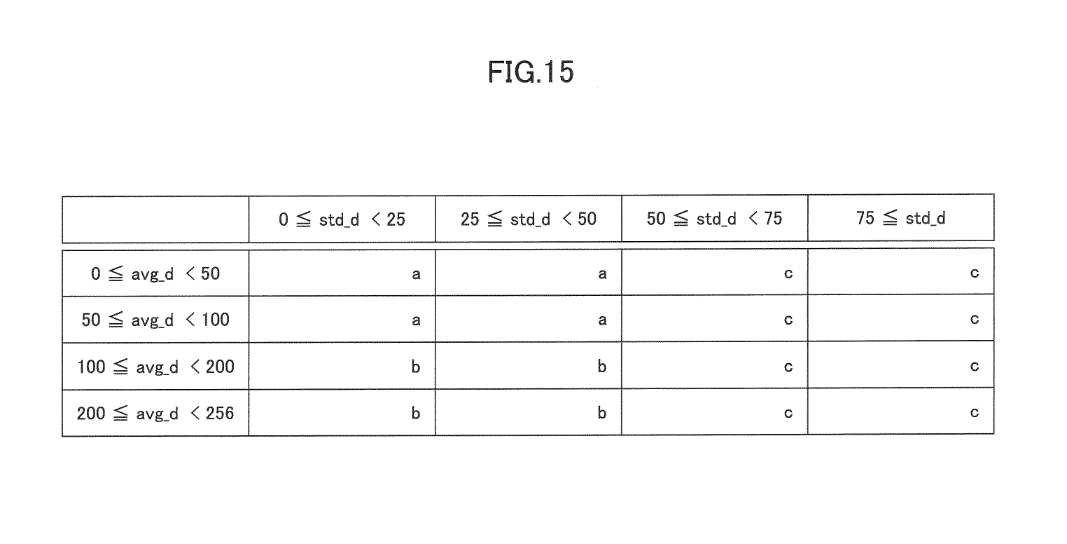

For example, when the determination is made using two features: an average luminance (avg_d) of the pixels of the selected object area and a standard deviation (std_d) of luminances of the pixels of the selected object area, a two-dimensional LUT (look-up table) as shown in FIG. 15 may be used. For example, as shown in FIG. 15, special color patterns “a”, “b” and “c” may be predefined by considering the combination of the average luminance and the standard deviation of the luminances, and a corresponding one of the special color patterns can be associated with the selected object.

Alternatively, one of the processes of generation of special-color data may be selectively performed based on the kind of the selected object. In this embodiment, only when the selected object is a raster object, an area having the shape that is the same as the shape of the selected object is generated and the special-color data is generated. When the selected object is a vector object, the processing in which the same-shape area is generated is not performed.

### Embodiment 4

The present embodiment is directed to a modification of the process of generating a special-color data. In the present embodiment, the printing effect of the special color is associated beforehand with each of the objects in the document page, so that the special color printing effect of the document page can be determined.

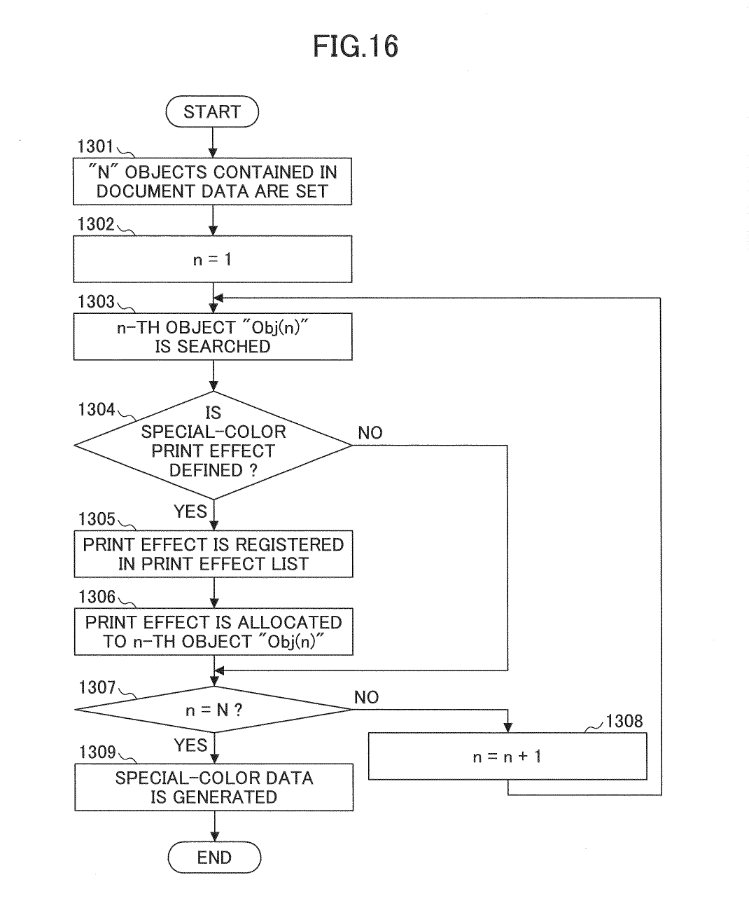

FIG. 16 is a flowchart for explaining the process of generating the special-color data according to the present embodiment. The processing of FIG. 16 is performed by the special-color data generating unit 106 according to the present embodiment. The process shown in FIG. 16 is similar to the process shown in FIG. 11, therefore a duplicate description thereof will be omitted, and only the difference between the processes of FIG. 11 and FIG. 16 will be described.

Generally, each of the objects contained in the document data used in the DTP may have a property. Using this property, registering the printing effects in a printing effect list is possible. In the process of FIG. 16, the printing effects (high gloss, gloss, etc.) of the respective objects are predefined (steps 1304 and 1305), one of the printing effects is assigned to the selected object (step 1306), and the special-color pattern is generated (step 1309).

However, there may be a case in which two or more objects contained in the document page (one page) have incompatible printing effects, or a case in which the image forming device (image output device) is unable to perform the printing effect predefined for the object. In such cases, it is necessary to replace the defined printing effect by a feasible printing effect. For this purpose, the priorities between the printing effects are predetermined, and the framework is prepared for modifying the defined printing effects in a range that can be reproduced by the image forming device used.

Regarding the determination of the priorities between the printing effects, for example, the upper limit and the lower limit of a fixing temperature, etc., may be managed as metadata, and the fixing temperature of a document can be determined by detecting whether a common range in the fixing temperature exists for all the objects in the document. If a process for the case in which the common range does not exist is defined beforehand, the fixing temperature of a document including arbitrary objects can be predetermined. Similarly, if other printing-process parameters are managed as a metadata item of each object, the optimum parameter for the document can be determined.

### Embodiment 5

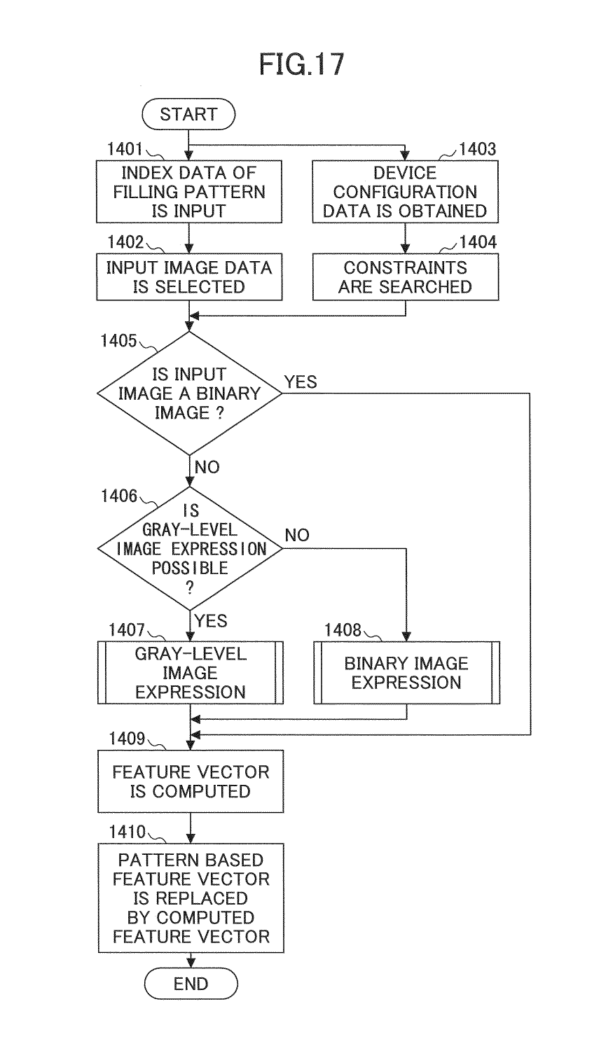

The present embodiment is directed to the process of the manual registration. FIG. 17 is a flowchart for explaining a detailed process of the manual registration performed by the pattern selecting unit 104 (step 808 in FIG. 8). The user can use an arbitrary input image as the parameter for generating special-color data. However, the expression capability of a specific special color varies depending on the reproduction capability of the image forming device, and it is necessary to convert the user input image into a data format that can be reproduced by the image forming device, based on the information of the device configuration.

Hence, as shown in steps 1403 and 1404 of the process of FIG. 17, the pattern selecting unit 104 obtains the device configuration information of the image forming device via a network and searches for constraints in the device configuration information.

In parallel to these steps, the pattern selecting unit 104 causes the user to input the index data (for example, a printing effect name) of a new filling pattern to be registered (step 1401). Next, the pattern selecting unit 104 causes the user to select the input image data (step 1402). As the input image data, any of color image data, gray-level image data and binary image data may be selected.

As shown in steps 1405 and 1406 of the process of FIG. 17, when the input image data is a color image or a gray level image and generating the gray level image expression is not possible by the image forming device, the pattern selecting unit 104 converts the input image data into a binary image expression by using an appropriate converting method (step 1408). When the input image data is a binary image, the pattern selecting unit 104 uses the input image data as a filling pattern without change.

As the binarization method of the gray-level image, for example a simple binarization using a fixed threshold, or an adaptive binarization method commonly used in document image processing may be used. When the image data distribution is unbalanced, a method using a median value of pixel values of the input image as a threshold may be used.

When the input image data is a color image, the pattern selecting unit 104 converts the input image data into a gray-level image expression (step 1407).

Next, the pattern selecting unit 104 computes the feature vector as described above by using the image information of a specific area of the input image separately designated (step 1409). It is assumed that “A” denotes the feature vector computed. Next, the pattern selecting unit 104 replaces the feature vector computed from the filling pattern by this feature vector A, and uses the feature vector A as a feature vector of the filling pattern concerned (step 1410).

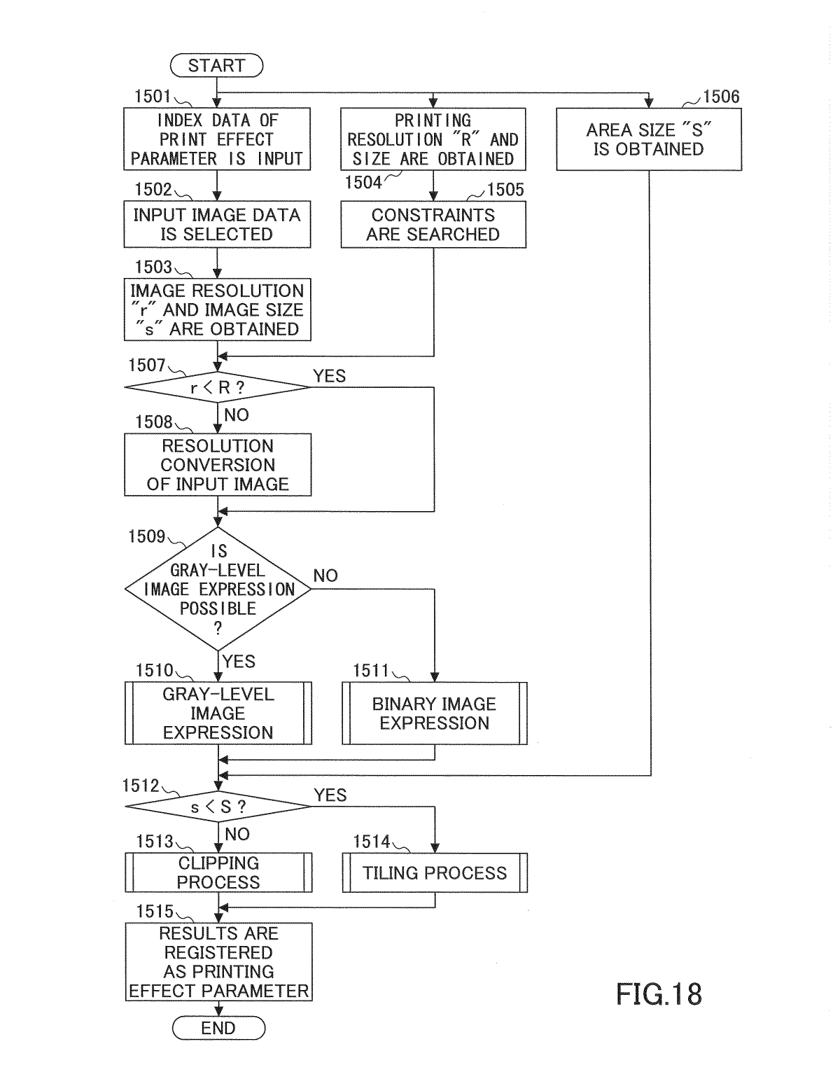

FIG. 18 is a flowchart for explaining a detailed procedure of the step 1403 of FIG. 17. The process shown in FIG. 18 is similar to the process shown in FIG. 17, therefore a duplicate description thereof will be omitted, and only the difference between the processes of FIG. 17 and FIG. 18 will be described.

As shown in FIG. 18, the pattern selecting unit 104 obtains a resolution “R” and a size “S” of the special color data that can be reproduced by the image forming device (step 1504), and compares the resolution “R” and size “S” with the resolution “r” and size “s” of the input image designated by the user, respectively (steps 1507 and 1512). Based on the comparison results, the pattern selecting unit 104 performs the resolution conversion of the input image (step 1508), and a clipping process of the input image (step 1513) or a tiling process of the input image (step 1514).

When the resolution “r” of the input image exceeds the maximum resolution “R” that can be reproduced by the image forming device, the pattern selecting unit 140 converts the resolution “r” of the input image into “R” and uses “R” as the resolution of the input image (step 1508).

Similarly, the pattern selecting unit 140 obtains the number of tones per pixel (the number of bits) which can be reproduced by the image forming device (step 1504). Based on the comparison result, the pattern selecting unit 140 performs the binary image expression of the special-color data (step 1511) or the gray-level image expression of the special-color data (step 1510).

When the size of the input image is larger than the size of the image area concerned (step 1512), the pattern selecting unit 140 performs the clipping process of the input image so as to suit the size of the image area concerned (step 1513).

On the other hand, when the size of the input image is smaller than the size of the image area concerned (step 1512), the pattern selecting unit 140 performs the tiling process in which two or more input images are pasted, so as to adjust the size of the filling pattern according to the size of the image area concerned (step 1514). Alternatively, another method, such as scaling of the input image, may be used in any case.

### Embodiment 6

The present embodiment is directed to the printing effect of the special color. In the present embodiment, it is assumed that the printing effects are designated for the objects in the document by the user, respectively. It is determined whether the designated printing effects of the objects are conformable. If there is a mismatching printing effect, the mismatch is corrected by replacing the mismatching printing effect with a similar printing effect. If the replacement is impossible, the user may be notified of it and may be requested to designate a new printing effect again.

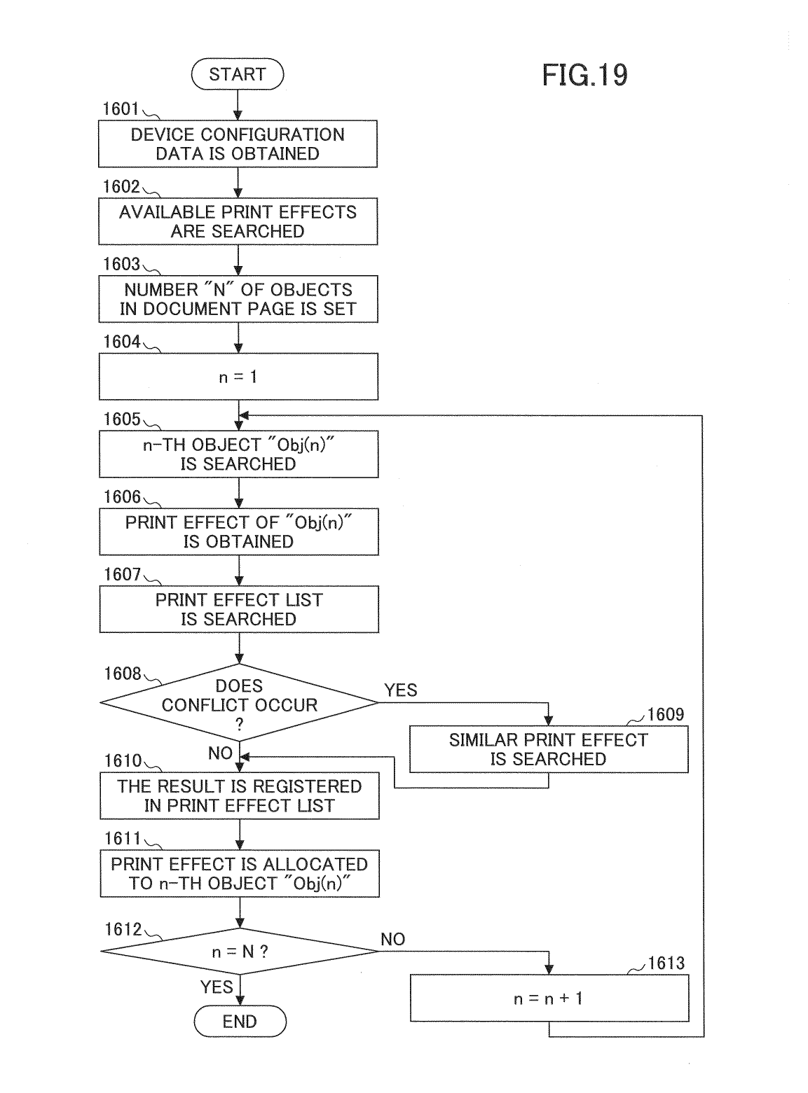

FIG. 19 is a flowchart for explaining a process of generating a special-color data which is performed by the special-color data generating unit 106 according to the present embodiment.

First, the device configuration data of the image forming device is obtained (step 1601), and the available special color printing effect is searched for (step 1602).

Next, the printing effect designated for the n-th object “Obj(n)” in the document is obtained (step 1606). The special-color data generating unit 106 searches the printing effect list (step 1607), and determines whether there is any printing effect of an object in the same document page which conflicts with the obtained printing effect (step 1608). When the conflict occurs, the special-color data generating unit 106 searches for a predefined similar printing effect and replaces the obtained printing effect with the similar printing effect (step 1609). The special-color data generating unit 106 registers the printing effect of the n-th object into the printing effect list (step 1610). The printing effect is assigned to the n-th object (step 1611). The above procedure of steps 1605-1611 is repeatedly performed for all the objects in the document, and the special-color data is generated.

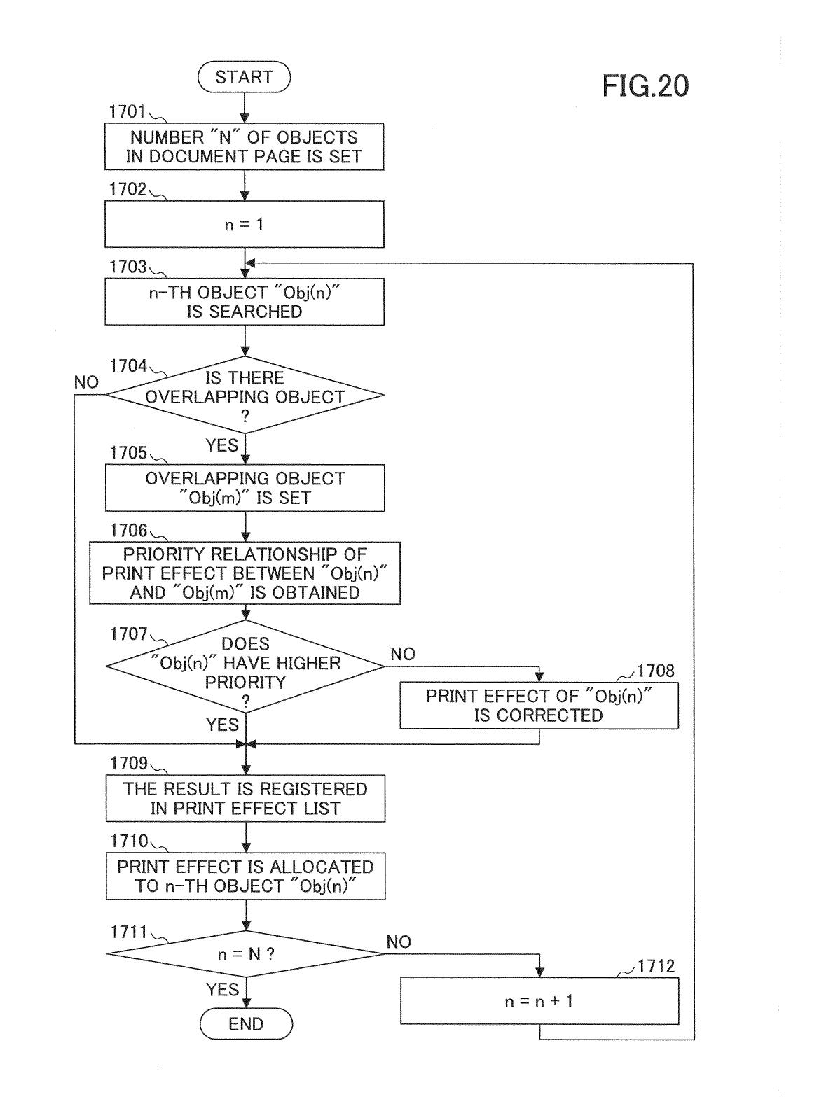

FIG. 20 is a flowchart for explaining a modification of the special-color data generating process according to the present embodiment. The process shown in FIG. 12 is similar to the process shown in FIG. 16, therefore a duplicate description thereof will be omitted, and only the difference between the processes of FIG. 16 and FIG. 20 will be described.

In this modification, it is assumed that there are overlapping objects in the same document page and the special color printing is designated for such objects. In this case, the printing effects of the overlapping objects are determined so that the conformable printing effects may be obtained.

As shown in steps 1703-1705 of the process of FIG. 20, when there is the object-2 “Obj(m)” which overlaps the object-1 “Obj(n)” in the document page, the priority relationship of the printing effects of the object-1 and the object-2 is obtained (step 1706). When the object-1 has a lower priority, the special-color data generating unit 106 corrects the printing effect of the object-1 (step 1708). For example, when the area (object-2) overlaps the area (object-1), priority is given to applying the filling pattern to the area (object-2).

### Embodiment 7

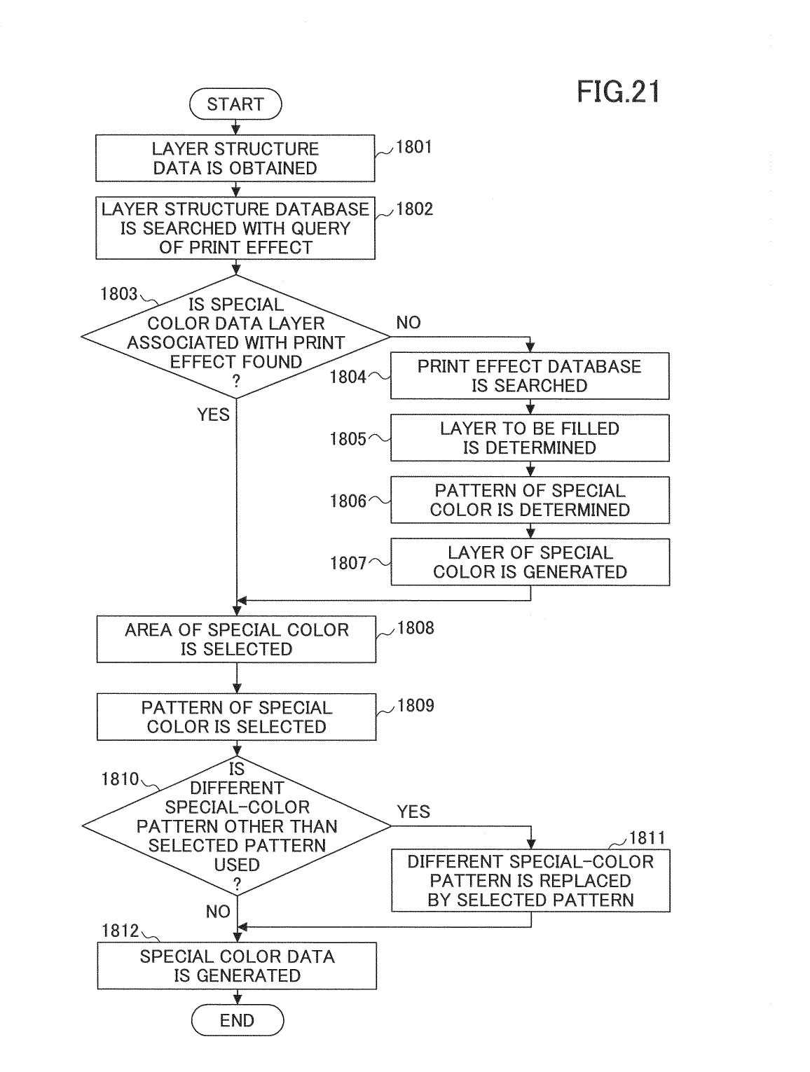

The present embodiment is directed to a process in which the pattern filling is performed using only a special color pattern (a selected special color pattern) associated with a specific printing effect. FIG. 21 is a flowchart for explaining a process performed by the special-color data generating unit 106 according to the present embodiment.

In the process shown in FIG. 21, the special-color data generating unit 106 obtains the layer structure data of the document (step 1801), and searches the layer structure database (DB) by setting the printing effect as a query (step 1802).

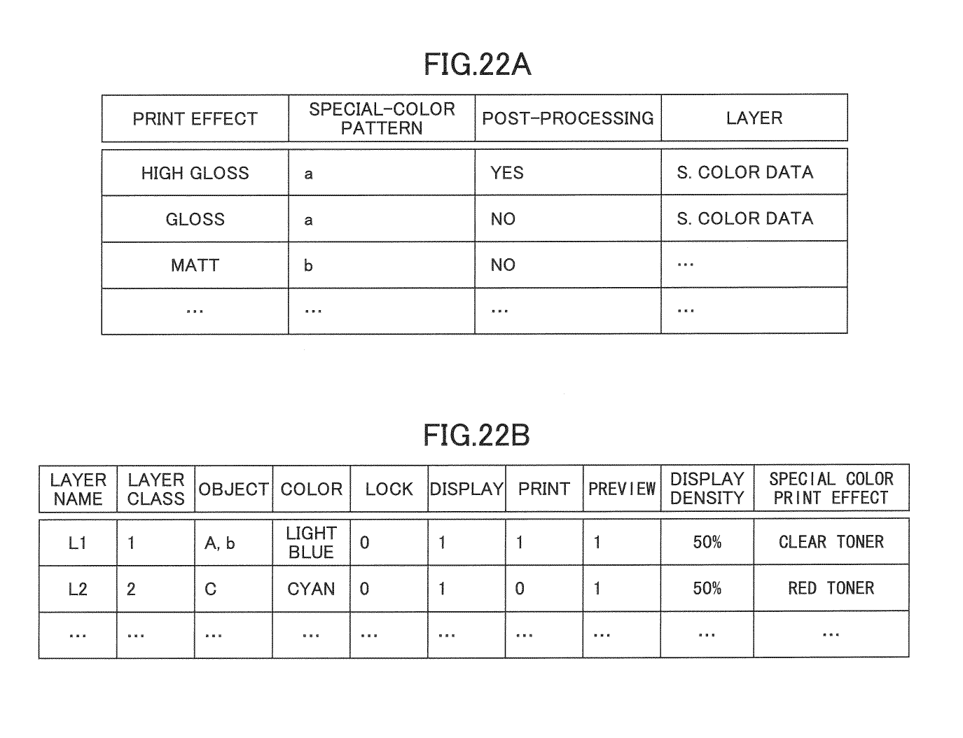

When any special-color data layer associated with the printing effect designated by the user is found (step 1803), the special-color data generating unit 106 searches the printing effect database (DB) shown in FIG. 22A (step 1804), determines the layer to be filled and the selected special color pattern (steps 1805 and 1806), and generates the special color layer (step 1807).

Next, the special-color data generating unit 106 causes the user to select the special color area (step 1808). When a special color pattern other than the selected special color pattern is currently being used (steps 1809 and 1810), the special-color data generating unit 106 replaces the currently used special color pattern with the selected special color pattern (step 1811) and generates the special-color data (step 1812).

FIG. 22A shows an example of a printing effect database which is searched by the special-color data generating unit 106. In the printing effect database, the special-color patterns associated with the printing effects, such as high gloss, gloss, and matt, are set up beforehand. The matt of FIG. 22A means a printing effect which is formed by a halftone dot pattern with a high frequency and the gloss is lost.

In the above-described process, for example, when one printing effect is designated from the printing effects of FIG. 22A by the user, its associated special color pattern is uniquely determined. In order to restrict the usable special color patterns only to the special color patterns shown in FIG. 22A, it is determined in the image drawing stage whether another pattern different than the selected special color pattern is being used (step 1810). When the other pattern is being used, the currently used pattern is replaced by the selected special color pattern (step 1811).

FIG. 22B shows an example of data items of the layers being used. As the layer structure data used by a normal DTP system, there are the data items shown in FIG. 22B, such as a layer name, and these data items are managed for each layer.

The layer name is used to distinguish each layer. After uniqueness of the name of each layer given as an initial value by the system is secured, the user may change freely the layer name. The layer class indicates the order of overlapping of the effect at the time of printing or displaying in the DTP. The object is used to manage the ID of the object contained in each layer. Fundamentally, one object belongs to one layer. The color indicates a display color used when the object is displayed in the display screen of the DTP. The lock indicates the permission of writing or correction to the layer concerned, in order to protect the content. The lock that is set to 0 indicates an unlocked state, and the lock that is set to 1 indicates a locked state. The display indicates the permission of the screen displaying in the DTP. The display that is set to 0 indicates that the screen displaying is not permitted, and the display that is set to 1 indicates that the screen displaying is permitted. The print is a flag indicating whether the layer concerned is to be used for printing. The print that is set to 1 indicates that the layer is to be used for printing, and the print that is set to 0 indicates that the layer is not to be used for printing. The preview is a flag indicating whether a preview reflects a change of the content of a display immediately. The preview that is set to 0 indicates that the preview does not reflect the change, and the preview that is set to 1 indicates that the preview reflects the change. The display density indicates the density of a display of the object by the display color. The special color printing effect is text information that indicates which printing effect or white special color toner of the special color printing each layer is associated with. By accessing the special color printing effect in the layer structure data, the image forming device determines the toner and the setting which are used for printing of the layer concerned.

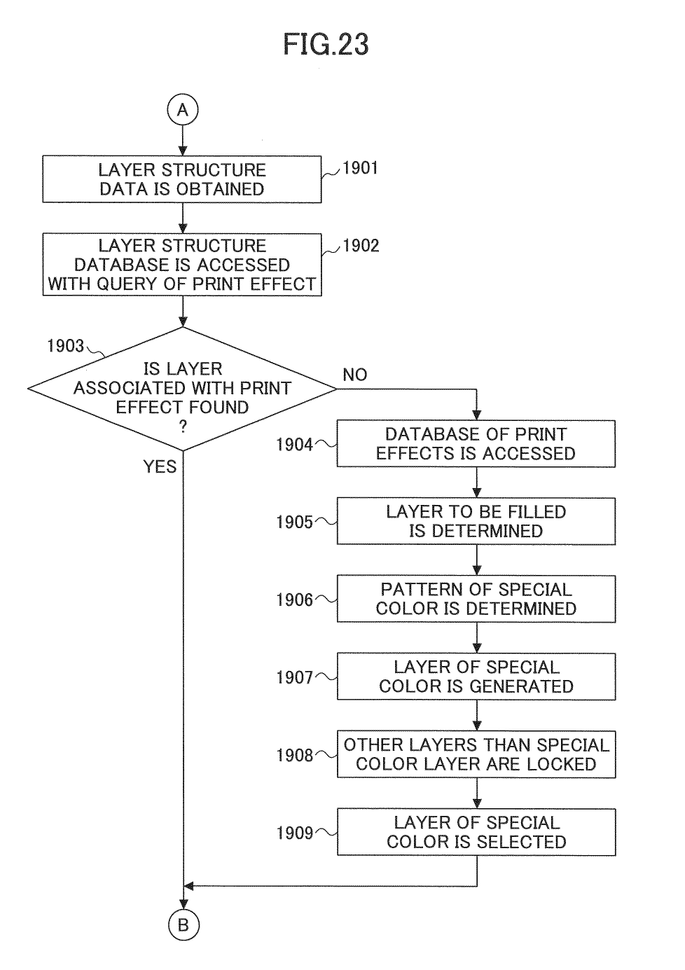

An example of the database which manages the relationship between the layers and the printing effects used in the present embodiment is shown in FIG. 22A. In this database, the special color pattern, the presence of post-processing, and the information of the layer to be filled with the special color data are associated and managed. The process shown in FIG. 21 may be modified so that, in order to restrict the layers to be filled only to the layers associated with the special color printing effects, other layers different from the layers associated with the special color printing effects are set in a locked state. FIG. 23 is a flowchart for explaining such a process. The process shown in FIG. 23 is similar to the process shown in FIG. 21, therefore a duplicate description thereof will be omitted, and only the difference between the processes of FIG. 21 and FIG. 23 will be described.

In the process shown in FIG. 23, the processing of steps 1901-1907 is the same as the processing of steps 1801-1807 of FIG. 21, and the processing of steps 1908 and 1909 of FIG. 23 is newly added.

In a case of a document for the special color printing, by using the printing effect parameter as a special parameter, the special color printing effect may be expressed in the document regardless of the kind of the layer to be filled. However, in this case, a demerit, such as a reduction of readability, may take place. To avoid the problem, it is preferred that the system is configured to ensure that the information of the special color is written only to the special color layer.

In the process shown in FIG. 23, the special-color data generating unit 106 sets other layers than the layer to be filled (the special color layer) in a locked state (step 1908), and sets the layer to be filled (the special color layer) in a selected state (step 1909). Hence, it is possible to prevent the writing of the special color information to the layers other than the special color layer at the time of writing in the processing of subsequent steps 1808-1812 in the process of FIG. 21.

The parameters of the printing process and the post-processing process required for the special color printing are associated with the printing effects, and the parameters associated with the printing effects are managed. This can be realized using the printing effect database shown in FIG. 22A. The special color patterns in FIG. 22A are unique special color patterns indicating the printing effects. For example, swatches commonly used in Adobe Illustrator (registered trademark) may be used as the special color patterns. The column of the post-processing in the printing effect database indicates the use of a glosser for increasing the gloss level of the paper surface, for example. The column of the layer in the printing effect database indicates the layer to which the special color pattern is written. The special color pattern may be written to the layer only, and may be written to another layer.

As the filling pattern of the special color, the patterns as shown in FIG. 3B may be used. These patterns differ in tone, a feeling of gloss, a feeling of unevenness, a feeling of touch, etc., therefore it is necessary to conduct a preliminary experiment using the actual printing process in order to check the printing effects, so that the printing effects are associated with the above-described printing effects.

### Embodiment 8

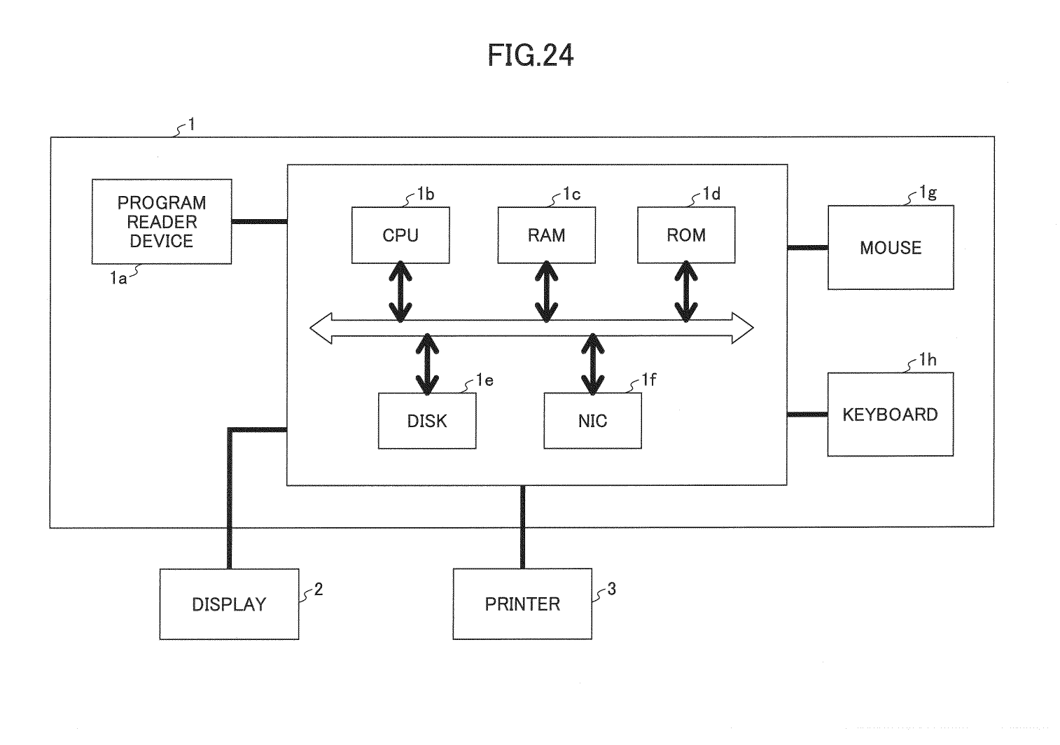

FIG. 24 shows the hardware composition of an image processing device in which the image forming device according to the present disclosure is implemented by software.

As shown in FIG. 24, the image processing device 1 includes a program reader device 1a, a CPU 1b to control the whole image processing device, a RAM 1c used as a work area of the CPU 1b, a ROM 1d to store a control program of the CPU 1b, a hard disk drive 1e, an NIC 1f to communicate with an external device via a network, a mouse 1g, a keyboard 1h, a display 2 to display image data and receive input data when the display screen is touched directly by the user, and an image forming device 3, such as a color printer. The image processing device 1 shown in FIG. 24 may be constructed by, for example, a workstation, a personal computer, etc.

In the image processing device 1 shown in FIG. 24, the functions of the pre-processing unit, the feature extraction processing unit, the pattern selecting unit, and the special-color data generating unit, as shown in FIG. 1, may be incorporated in the CPU 1b. When storing the filling patterns, image data, etc., the memory units, including the RAM 1c, the ROM 1d, and the hard disk 1e, may be used. For example, the processing functions performed by the CPU 1b may be provided by a software package or an information recording medium, such as a CD-ROM or a magnetic disk. In the example shown in FIG. 24, a disk drive unit (not shown) which accesses an information recording medium when the recording medium is set is also provided.

As described above, the image forming method of the present disclosure can be carried out by a general-purpose computer system including a display, in which a control program stored in the information recording medium, such as a CD-ROM, is installed. The control program, when executed by the CPU of the computer system, causes the CPU to perform the image forming method of the present disclosure. In this case, the program for performing the image forming method of the present disclosure may be offered in a state in which the program is recorded on the recording medium. The information recording medium in which the control program is stored is not limited to the CD-ROM. For example, a ROM, a RAM, a flash memory, a magneto-optical disk, etc., may be used instead. In the example shown in FIG. 24, the control program stored in the information recording medium is installed into the hard disk 1e, and the program is loaded in the RAM 1c and executed by the CPU 1b so that the image-processing functions are carried out.

As described in the foregoing, according to the present disclosure, the amount of the supplementary work concerning generation of the pattern data required to obtain the printing effect of a special color can be reduced, and the working efficiency can be increased.

The image forming device of the present disclosure is not limited to the specifically disclosed embodiments, and variations and modifications may be made without departing from the scope of the present disclosure.

The present application is based upon and claims the benefit of priority of Japanese Patent Application No. 2012-043905, filed on Feb. 29, 2012, the contents of which are incorporated herein by reference in their entirety.

What is claimed is:

1. An image forming device including a processing unit to control an image formation unit to form an image on a print medium, the processing unit comprising:
a feature extraction processing unit configured to extract a predetermined feature from an area in a predetermined image, the image area to be filled with a printing material of a special color;
a pattern selecting unit configured to search a registering unit in which filling patterns are registered, and select, from among the filling patterns registered in the registering unit, a filling pattern having a feature most closely approximating the extracted predetermined feature; and
a special-color data generating unit configured to generate a special-color data of the selected filling pattern,
wherein the image formation unit is controlled to form an image in which the special-color data from the special-color data generating unit overlaps image data of the area of the predetermined image.

2. The image forming device according to claim 1, wherein the filling pattern is associated with a first feature extracted from the filling pattern and the filling pattern and the first feature are registered into the registering unit, and when registering a specific image in the registering unit as a filling pattern, a second feature extracted from the specific image is associated with the filling pattern, and the second feature is registered instead of the first feature.

3. The image forming device according to claim 1, wherein the predetermined feature extracted is one of an average color of pixels of the image area, a standard deviation of pixel values of the image area, and an edge amount of the image area, or a combination of the average color, the standard deviation and the edge amount.

4. The image forming device according to claim 1, wherein a result of a binarization process of the predetermined image including a specific image, is registered in the registering unit as a filling pattern.

5. The image forming device according to claim 1, wherein the special-color data generating unit is configured to prepare an area having a shape that is the same as a shape of the area of the predetermined image in a special-color printing layer and generate the special-color data to fill the prepared area with the selected filling pattern.

6. The image forming device according to claim 1, wherein the image area to be filled with the printing material of the special color is an image in a raster form.

7. The image forming device according to claim 1, wherein the registering unit is configured to set up a resolution and the number of tones of each of the filling patterns depending on a reproduction capability of printing the special color of the image formation unit.

8. The image forming device according to claim 1, wherein the special-color data generating unit is configured to restrict a printing effect of the special-color data usable in a document image depending on a reproduction capability of printing the special color of the image formation unit.

9. The image forming device according to claim 1, wherein the pattern selecting unit is configured to determine priorities between the selected filling patterns when the selected filling patterns overlap each other.

10. An image forming method performed by an image forming device including a processing unit to control an image formation unit to form an image on a print medium, the image forming method comprising:
extracting, by a feature extraction processing unit, a predetermined feature from an area in a predetermined image, the image area to be filled with a printing material of a special color;
selecting, by a pattern selecting unit, a filling pattern having a feature most closely approximating the extracted predetermined feature by searching a registering unit in which filling patterns are registered;
generating, by a special-color data generating unit, a special-color data of the selected filling pattern; and
controlling the image formation unit to form an image in which the special-color data overlaps image data of the area of the predetermined image.

11. A non-transitory computer-readable recording medium storing a program which, when executed by a computer, causes the computer to perform the image forming method of claim 10.
